(19) United States
(12) Patent Application Publication
(10) Pub. No.: US 2007/0288407 A1
(43) Pub. Date: Dec. 13, 2007

(54) Information-processing apparatus, method of processing information, learning device and learning method

(76) Inventors: Ryunosuke Nishimoto, Saitama (JP); Jun Tani, Saitama (JP); Masato Ito, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/730,084

(22) Filed: Mar. 29, 2007

(30) Foreign Application Priority Data
Mar. 30, 2006 (JP) 2006-093108

(51) Int. Cl. G06F 15/18

(52) U.S. Cl. 706/16

(57) ABSTRACT

An information-processing apparatus has a recurrent neural network containing an input node that allows data to be input, an output node that outputs data based on the data input through the input node, context input and output nodes, a context loop that returns a value indicating internal state in the network from the context output node to the context input node, and a recurrent loop that returns output from the network at predetermined time to the network as a next input to the network. The apparatus has a production device that produces a current input to the network by adding output from the output node into an immediately preceding input to the network at a predetermined rate and produces a current input to the context input node by adding output from the context output node into an immediately preceding input to the context input node at a predetermined rate.

### CROSS REFERENCE TO RELATED APPLICATION

The present invention contains subject matters related to Japanese Patent Application JP 2006-093108 filed in the Japanese Patent Office on Mar. 30, 2006, the entire contents of which being incorporated herein by reference.

### BACKGROUND OF THE INVENTION

1. Field of the Invention

The present invention relates to an information-processing apparatus, a method of processing information, a learning device, a learning method, and program products. More particularly, it relates to an information-processing apparatus and the like in which long time sequences can be learnt or produced in a recurrent neural network (hereinafter, referred to as “RNN”).

2. Description of Related Art

Feed-forward networks included in artificial neural networks have been broadly applied to any pattern recognition, any learning of unknown function or the like. In the feed-forward networks, output is determined by only current inputs without taking into consideration any past history. It is difficult to learn pieces of time-series information to cope with them appropriately.

Models of the feed-forward networks that can cope with the pieces of time-series information by converting their time-series pattern to their space pattern have been proposed. In these models, history to be considered is limited.

Alternatively, models of RNN have been proposed. The RNN is a neural network having a recurrent loop so-called “a context loop” and can cope with pieces of time-series information by performing any processing based on internal state in the context loop, thereby preventing the history to be considered from being limited.

An article, “Learning to generate combinatorial action sequences utilizing the initial sensitivity of deterministic dynamical systems” by Ryu NISIMOTO and Jun TANI, Neural Networks 17, 2004, p 925-p 933 has disclosed such a technology that action sequences of a robot can be changed by utilizing the RNN to learn and produce action sequences (time-series patterns) of the robot and changing initial values of the internal state of the RNN.

### SUMMARY OF THE INVENTION

The technology disclosed in the above article is suitable for action sequences including a small number of time steps in the RNN. If, however, the action sequences include a large number of time steps in the RNN, it is difficult to learn or produce such long time action sequences having the large number of time steps.

It is desirable to provide an information-processing apparatus and the like in which such the long time action sequences can be learnt or produced in the RNN.

According to an embodiment of the present invention, there is provided an information-processing apparatus equipped with a recurrent neural network. The recurrent neural network contains an input node that allows data to be input, an output node that outputs data based on the data input through the input node, a context input node, a context output node, a context loop that returns a value indicating internal state in the network from the context output node to the context input node, and a recurrent loop that returns output from the network at predetermined time to the network as a next input to the network. The information-processing apparatus has a production device that produces a current input to the network by adding output from the output node into an immediately preceding input to the network at a predetermined rate, and produces a current input to the context input node by adding output from the context output node into an immediately preceding input to the context input node at a predetermined rate.

Further, the production device produces internal state of the input node at immediate future after current time by adding the output from the output node into the internal state of the input node at the current time at a predetermined rate, and produces internal state of the context input node at immediate future after the current time by adding the output from the context output node into the internal state of the context input node at the current time at a predetermined rate.

An initial value to be given to the context input node is obtained by learning. In the learning, any influence by an error in the internal state of the context input node at predetermined time on an error in the internal state of the context output node immediately before the predetermined time is adjusted.

According to another embodiment of the present invention, there is provided a method of processing information by using a recurrent neural network containing an input node that allows data to be input, an output node that outputs data based on the data input through the input node, a context input node, a context output node, a context loop that returns a value indicating internal state in the network from the context output node to the context input node, and a recurrent loop that returns output from the network at predetermined time to the network as a next input to the network. The method includes the steps of producing a current input to the network by adding output from the output node into an immediately preceding input to the network at a predetermined rate, and producing a current input to the context input node by adding output from the context output node into an immediately preceding input to the context input node at a predetermined rate.

According to further embodiment of the present invention, there is provided a program product that allows a computer to perform the above method of processing information by using the recurrent neural network.

In the above embodiments of the invention, the current input to the network is produced by adding output from the output node into the immediately preceding input to the network at a predetermined rate and the current input to the context input node is produced by adding output from the context output node into the immediately preceding input to the context input node at a predetermined rate. This enables long time action sequence to be learnt or produced in the RNN.

According to an additional embodiment of the present invention, there is provided learning device that learns an initial value provided to a context input node of the information-processing apparatus. The information-processing apparatus is equipped with a recurrent neural network containing an input node that allows data to be input, an output node that outputs data based on the data input through the input node, a context input node, a context output node, a context loop that returns a value indicating internal state in the network from the context output node to the context input node, and a recurrent loop that returns output from the network at predetermined time to the network as a next input to the network.

The learning device contains an adjusting device that adjusts any influence by an error in the internal state of the context input node at predetermined time on an error in the internal state of the context output node immediately before the predetermined time.

The adjusting device sets a value obtained by dividing the error in the internal state of the context input node at predetermined time by a positive coefficient as the error in the internal state of the context output node immediately before the predetermined time, to adjust the influence by the error in the internal state of the context input node at the predetermined time on the error in the internal state of the context output node immediately before the predetermined time.

According to still another embodiment of the present invention, there is provided a learning method of learning an initial value to be provided to a context input node of an information-processing apparatus. The information-processing apparatus is equipped with a recurrent neural network containing an input node that allows data to be input, an output node that outputs data based on the data input through the input node, a context input node, a context output node, a context loop that returns a value indicating internal state in the network from the context output node to the context input node, and a recurrent loop that returns output from the network at predetermined time to the network as a next input to the network. This learning method includes a step of adjusting any influence by an error in the internal state of the context input node at predetermined time on an error in the internal state of the context output node immediately before the predetermined time.

According to still further embodiment of the present invention, there is provided a program product that allows a computer to perform the above learning method of learning an initial value to be provided to a context input node of an information-processing apparatus.

In the above embodiments of the learning device and method of the invention, any influence by an error in the internal state of the context input node at the predetermined time on an error in the internal state of the context output node immediately before the predetermined time can be adjusted.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a block diagram for showing a configuration of an embodiment of an information-processing apparatus according to the invention;

FIG. 2 is a schematic diagram for showing a configuration of a recurrent neural network (RNN);

FIG. 3 is a flowchart for describing production processing in the information-processing apparatus;

FIG. 4 is a flowchart for describing learning processing in the information-processing apparatus;

FIGS. 5A through 5E are drawings each for showing action of a humanoid robot that was used in an experiment;

FIG. 6 is a graph for showing a change of learning error in the experiment of the robot;

FIGS. 7A through 7C are graphs each for showing comparison data between teacher data and produced data in the experiment of the robot;

FIG. 8 is a graph for showing a result of analyzing main components of an initial value of the context input data in the experiment of the robot; and

FIG. 9 is a block diagram for showing a configuration of an embodiment of the computer to which the invention is applied.

### DESCRIPTION OF THE PREFERRED EMBODIMENTS

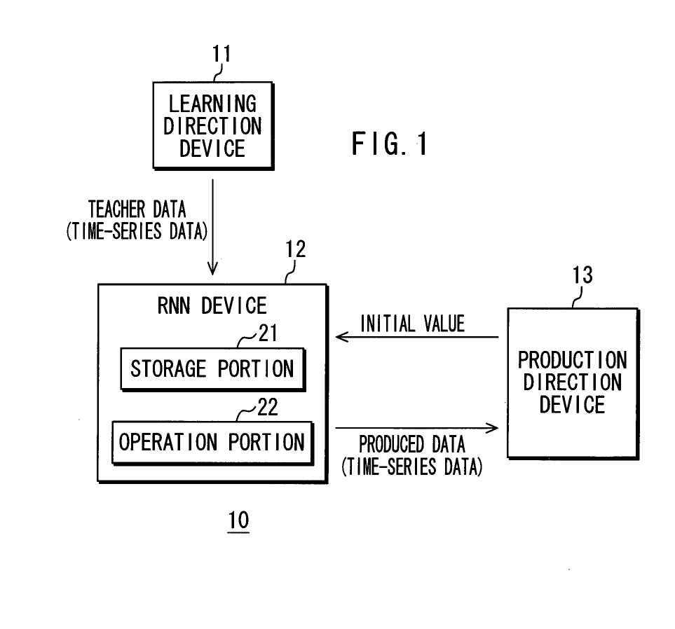

The following will describe embodiments of the present invention with reference to the accompanied drawings. FIG. 1 shows a configuration of an embodiment of an information-processing apparatus 10 according to the invention.

The information-processing apparatus 10 contains a learning direction device 11, RNN device 12, and production direction device 13 and performs learning processing on time-series data (time-series pattern).

The learning direction device 11 directs the RNN device 12 to perform learning processing on time-series data by supplying the RNN device 12 with the time-series data as teacher data.

The RNN device 12 contains a storage portion 21 and an operation portion 22. In the RNN device 12, recurrent neural network (RNN) with three layers including an input layer 51, an output layer 53, and an intermediate layer 52 therebetween is constructed.

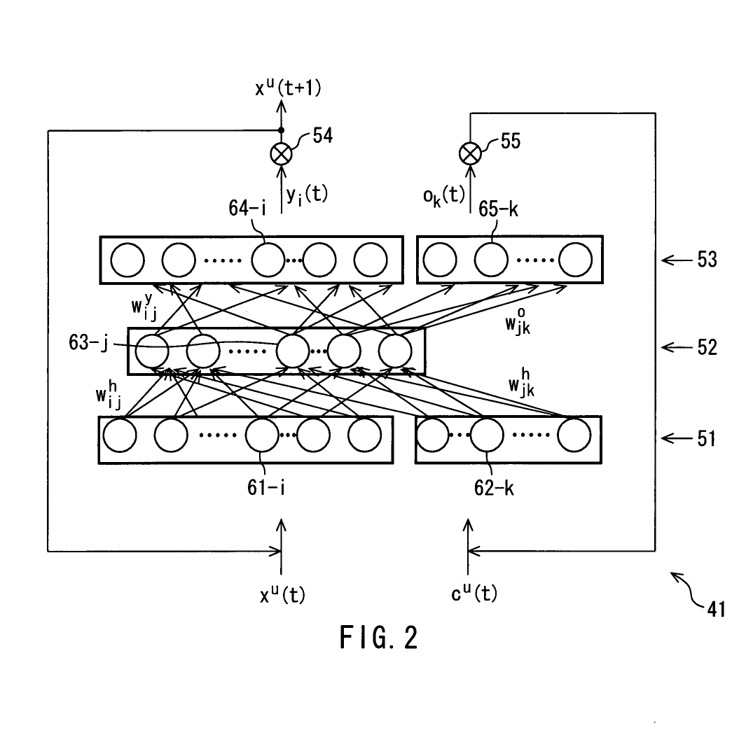

FIG. 2 schematically shows a configuration of RNN 41 constructed in the RNN device 12.

In the RNN 41 shown in FIG. 2, any learning such that state vector x^{u} (t+1) at time (t+1) is predicted and output based on input state vector x^{u} (t) at time (t) is performed. The RNN 41 has a recurrent loop so-called “a context loop” that indicates internal state of the network and can perform any processing based on the internal state to learn time development theorem of the time-series data of interest. A node of the context loop that is situated at the input layer 51 of the RNN 41 is referred to as “context input node 62-k (k=1, 2, . . . , K). A node of the context loop that is situated at the output layer 53 of the RNN 41 is referred to as “context output node 65-k (k=1, 2, . . . K). A node other than the context input node that is situated at the input layer 51 of the RNN 41 is referred to as “input node 61-i (i=1, 2, . . . , I). A node that is situated at the intermediate layer 52 of the RNN 41 is referred to as “hidden node 63-j (j=1, 2, . . . , J). A node other than the context output node that is situated at the output layer 53 of the RNN 41 is referred to as “output node 64-i (i=1, 2, . . . , I). To the input node 61-i, for example, signal of a sensor or a motor is input.

It is to be noted that if each node is indistinguishable in the input node 61-i, the context input node 62-k, the hidden node 63-j, the output node 64-i, and the context output node 65-k, they are simply referred to as the input node 61, the context input node 62, the hidden node 63, the output node 64, and the context output node 65, respectively.

Referring back to FIG. 1, the operation portion 22 performs any arithmetic computations based on the teacher data received from the learning direction device 11 with the input node 61, the context input node 62, the hidden node 63, the output node 64, the context output node 65, weight coefficient of each node in the input layer 51 and the intermediate layer 52, and weight coefficient of each node 3 in the intermediate layer 52 and the output layer 53 being set as variable so that the weight coefficient (weight coefficient w^{h}ᵢⱼ and w^{h}ⱼₖ, which will be described later) between the nodes of the input layer 51 and the nodes of the intermediate layer 52, the weight coefficient (weight coefficient w^{y}ᵢⱼ and w^{o}ⱼₖ, which will be described later) of the nodes of the intermediate layer 52 and the nodes of the output layer 53, and the initial values to be provided to the context input node 62-k can be made optimum, respectively. Thus, such the operation that obtains the optimal weight coefficients and the optimal initial values to be provided to the context input node 62-k relates to learning of time-series data. The storage portion 21 stores the optimal weight coefficients thus obtained and the optimal initial values to be provided to the context input node 62-k thus obtained. When receiving the teacher data from the learning direction device 11, the RNN device 12 acts as learning device to learn the weight coefficients and the optimal initial values to be provided to the context input node 62-k, which are optimal to the teacher data.

When each node of the input layer 51, namely, the input nodes 61-i and the context input nodes 62-k receive their initial values from the production direction device 13, the operation portion 22 produces time-series data based on the initial values and outputs the time-series data thus produced to the production direction device 13 as produced data. In order to produce the time-series data, the weight coefficients and the optimal initial value to be provided to the context input node 62-k, which are obtained by the above learning, are used. When each node of the input layer 51 receive their initial values from the production direction device 13, the RNN device 12 acts as production device to produce the time-series data based on the initial values thus received.

The production direction device 13 directs the RNN device 12 to produce the time-series data of desired time step numbers (samples, times) by supplying the initial values to each node of the input layer 51 of the RNN 41.

The following will describe details of the RNN 41 with reference to FIG. 2.

The RNN 41 contains the input layer 51, the intermediate (hidden) layer 52, the output layer 53, and calculation portions 54, 55.

As described above, the input layer 51 has the input nodes 61-i (i=1, 2, . . . , I) and the context input nodes 62-k (k=1, 2, . . . , K). The intermediate layer 52 has the hidden nodes 63-j (j=1, 2, . . . , J). The output layer 53 has the output nodes 64-i (i=1, 2, . . . , I) and the context output nodes 65-k (k=1, 2, . . . , K).

To the input nodes 61-i, data x^{u}ᵢ(t) that is i-th item constituting the state vector x^{u}(t) at time t is input. To the context input node 62-k, data c^{u}ₖ(t) that is k-th item constituting the internal state vector c^{u}(t) of the RNN 41 at time t is input.

If the data x^{u}ᵢ(t) and the data c^{u}ₖ(t) are respectively input to the input nodes 61-i and the context input node 62-k, items of the data xᵢ(t) and cₖ(t) that are respectively output from the input nodes 61-i and the context input node 62-k are respectively represented by following equations (1) and (2):
xᵢ(t)=ƒ(xᵢ^{u}(t)) (1); and
cₖ(t)=ƒ(cₖ^{u}(t)) (2).

The functions f of the equations (1) and (2) include differentiable continuous function such as sigmoid function. These equations (1) and (2) mean that the data x^{u}ᵢ(t) and the data c^{u}ₖ(t) respectively input to the input nodes 61-i and the context input node 62-k are activated by the functions f and output from the input nodes 61-i and the context input node 62-k as the data xᵢ(t) and the data cₖ(t). It is to be noted that a superscript “u” of each of the data x^{u}ᵢ(t) and the data c^{u}ₖ(t) indicates internal state on the node before it has been activated, which is similar to other nodes.

Data h^{u}ⱼ(t) to be input to the hidden nodes 63-j can be represented by following equation (3) using weight coefficient w^{h}ᵢⱼ that represents a weight of combination between the input nodes 61-i and the hidden nodes 63-j and weight coefficient w^{h}ⱼₖ that represents a weight of combination between the context input nodes 62-k and the hidden nodes 63-j:
hⱼ^{u}=(t)Σwᵢⱼ^{h}xᵢ(t)+Σw^{h}ⱼₖ^{c}ₖ(t) (3).

Data hⱼ(t) output from the hidden nodes 63-j can be represented by following equation (4):
hⱼ(t)=ƒ(hⱼ^{u}(t) (4).

It is to be noted that sigma of a first term in the right side of the equation (3) means sum of all of the nodes i (i=1, 2, . . . , I) and sigma of a second term in the right side of the equation (3) means sum of all of the nodes k (k=1, 2, . . . , I).

Similarly, data y^{u}ᵢ(t) to be input to the output nodes 64-i, data yᵢ(t) output from the output nodes 64-i, data o^{u}ₖ(t) to be input to the context output nodes 65-k, and data oₖ(t) output from the context output nodes 65-k can be respectively represented by following equations (5), (6), (7), and (8):
yᵢ^{u}(t)=Σwᵢⱼ^{y}hⱼ(t) (5);
yᵢ(t)=ƒ(yᵢ^{u}(t) (6);
oₖ^{u}(t)=Σw^{o}ⱼₖhⱼ(t) (7); and
oₖ(t)=ƒ(oₖ^{u}(t)) (8).

In the equation (5), w^{y}ᵢⱼ is a weight coefficient indicating weight of combination of the hidden nodes 63-j and the output nodes 64-i and sigma means sum of all of the nodes j (j=1, 2, . . . , J). In the equation (7), w^{o}ⱼₖ is a weight coefficient indicating weight of combination of the hidden nodes 63-j and the context output nodes 65-k and sigma means sum of all of the nodes j (j=1, 2, . . . , J).

The calculation portion 54 calculates finite difference delta x^{u}ᵢ(t+1) between the data x^{u}ᵢ(t) at time t and the data x^{u}ᵢ(t+1) at time t+1 from data yᵢ(t) output from the output nodes 64-i according to the following equation (9) and then, calculates the data x^{u}ᵢ(t+1) at time t+1 according to the following equation (10) and output the calculated data x^{u}ᵢ(t+1).

$$\begin{matrix}Δ {x}_{i}^{u} ( t + 1 ) = \frac{( - {x}_{i}^{u} ( t ) + \frac{{y}_{i} ( t )}{α} )}{τ} & ( 9 ) \\ {x}_{i}^{u} ( t + 1 ) = Δ {x}_{i}^{u} ( t + 1 ) + {x}_{i}^{u} ( t ) = ( 1 - \frac{1}{τ} ) {x}_{i}^{u} ( t ) + \frac{{y}_{i} ( t )}{α τ} & ( 10 )\end{matrix}$$

It is to be noted that in these equations, alpha and tau indicate optional coefficients, respectively.

Thus, when the RNN 41 shown in FIG. 2 receives the data x^{u}ᵢ(t) at time t, the calculation portion 54 of the RNN 41 outputs the data x^{u}ᵢ(t+1) at time t+1. This data x^{u}ᵢ(t+1) output from the calculation portion 54 at time t+1 is also supplied to the input nodes 61-i, namely, fed back thereto.

The calculation portion 55 calculates finite difference delta c^{u}ₖ(t+1) between the data c^{u}ₖ(t) at time t and the data c^{u}ₖ(t+1) at time t+1 from data oₖ(t) output from the context output nodes 65-k according to the following equation (11) and then, calculates the data c^{u}ₖ(t+1) at time t+1 according to the following equation (12) and output the calculated data c^{u}ₖ(t+1).

$$\begin{matrix}Δ {c}_{k}^{u} ( t + 1 ) = \frac{( - {c}_{k}^{u} ( t ) + \frac{{o}_{k} ( t )}{α} )}{τ} & ( 11 ) \\ {c}_{k}^{u} ( t + 1 ) = Δ {c}_{k}^{u} ( t + 1 ) + {c}_{k}^{u} ( t ) = ( 1 - \frac{1}{τ} ) {c}_{k}^{u} ( t ) + \frac{{o}_{k} ( t )}{α τ} & ( 12 )\end{matrix}$$

This data c^{u}ₖ(t+1) output from the calculation portion 55 at time t+1 is also fed back to the context input nodes 62-k.

The equation (12) means that the internal state vector c^{u}(t+1) at next time can be obtained by adding the data oₖ(t) output from the context output nodes 65-k that is weighted by a coefficient α to the internal state vector c^{u}(t) in the network at a current time. In this sense, the RNN 41 shown in FIG. 2 constitutes continuous typed RNN.

Thus, when the RNN 41 shown in FIG. 2 receives the data x^{u}(t) c^{u}(t) at time t, the RNN 41 produces and outputs the data x^{u}(t+1), c^{u}(t+1) at time t+1 one after another so that if the weight coefficients w^{h}ᵢⱼ, w^{h}ⱼₖ, w^{y}ᵢⱼ, w^{o}ⱼₖ are obtained by learning, it is possible to produce time-series data at desired time steps by giving an initial value x^{u}(t₀)=X0 of the input data x^{u}(t) to be input to the input nodes 61 and an initial value c^{u}(t₀)=C0 of the context input data c^{u}(t) to be input to the context input nodes 62.

The following will describe production processing of the information-processing apparatus 10 that produces time-series data with reference to a flowchart shown in FIG. 3. It is to be noted that in FIG. 3, the weight coefficients w^{h}ᵢⱼ, w^{h}ᵢₖ, w^{y}ᵢⱼ, w^{o}ⱼₖ are obtained by learning, which will be described later.

First, at Step S11, the production direction device 13 supplies the RNN device 12 with the initial value X0 of the input data and the initial value C0 of the context input data.

At Step S12, the input nodes 61-i calculate the data xᵢ(t) according to the equation (1) and outputs the calculated data xᵢ(t) as well as the context input nodes 62-k calculate the data cₖ(t) according to the equation (2) and outputs the calculated data cₖ(t).

At Step S13, the hidden nodes 63-j calculate the data h^{u}ⱼ(t) according to the equation (3), calculate the data hⱼ(t) according to the equation (4), and outputs the calculated data hⱼ(t).

At Step S14, the output nodes 64-i calculate the data y^{u}ᵢ(t) according to the equation (5), calculate the data yᵢ(t) according to the equation (6), and outputs the calculated data yᵢ(t).

At Step S15, the context nodes 65-k calculate the data o^{u}ₖ(t) according to the equation (7), calculate the data oₖ(t) according to the equation (8), and outputs the calculated data oₖ(t).

At Step S16, the calculation portion 54 calculates the finite difference data Δx^{u}ᵢ(t+1) according to the equation (9), calculates the data x^{u}ᵢ(t+1) at time t+1 according to the equation (10), and outputs the calculated data x^{u}ᵢ(t+1) to the production direction device 13.

At Step S17, the calculation portion 55 calculates the finite difference data Δc^{u}ₖ(t+1) according to the equation (11), calculates the data c^{u}ₖ(t+1) at time t+1 according to the equation (12). The calculation portion 55 feeds (inputs) the calculated data c^{u}ₖ(t+1) back to the context input nodes 62-k.

At Step S18, the RNN device 12 determines whether or not the production of the time-series data is finished. At the Step S18, if it is determined that the production of the time-series data is not finished, the calculation portion 54, at Step S19, feeds the calculated data x^{u}ᵢ(t+1) at time t+1 back to the input nodes 61-i and the processing returns to the Step S12.

On the other hand, if it is determined that the production of the time-series data is finished by, for example, attaining the desired time step number, at the Step S18, the RNN device 12 finishes the production processing.

The following will describe learning of time-series data in the RNN device 12.

It is supposed that when, for example, a humanoid robot equipped with the information-processing apparatus 10 learns plural action sequences (actions), the weight coefficients w^{h}ᵢⱼ, w^{h}ⱼₖ between nodes of the input layer 51 and nodes of the intermediate layer 52 as well as the weight coefficients w^{y}ᵢⱼ, w^{o}ⱼₖ between nodes of the intermediate layer 52 and nodes of the output layer 53 correspond to all the action sequences.

In the learning processing, learning of time-series data corresponding to the plural action sequences is carried out simultaneously. Namely, in the learning processing, the RNNS 41 of the same number as that of the action sequences are prepared and the weight coefficients w^{h}ᵢⱼ, w^{h}ⱼₖ, w^{y}ᵢⱼ, w^{o}ⱼₖ are calculated for each action sequence so that their average value can become final weight coefficients w^{h}ᵢⱼ, w^{h}ⱼₖ, w^{y}ᵢⱼ, w^{o}ⱼₖ of one RNN 41. Repeating such the processing enables weight coefficients w^{h}ᵢⱼ, w^{h}ⱼₖ, w^{y}ᵢⱼ, w^{o}ⱼₖ of the RNN 41 that is used in the production processing to be obtained. In the learning processing, the initial value c^{u}(t0)=C0 of the context input data is also obtained for each action sequence at the same time.

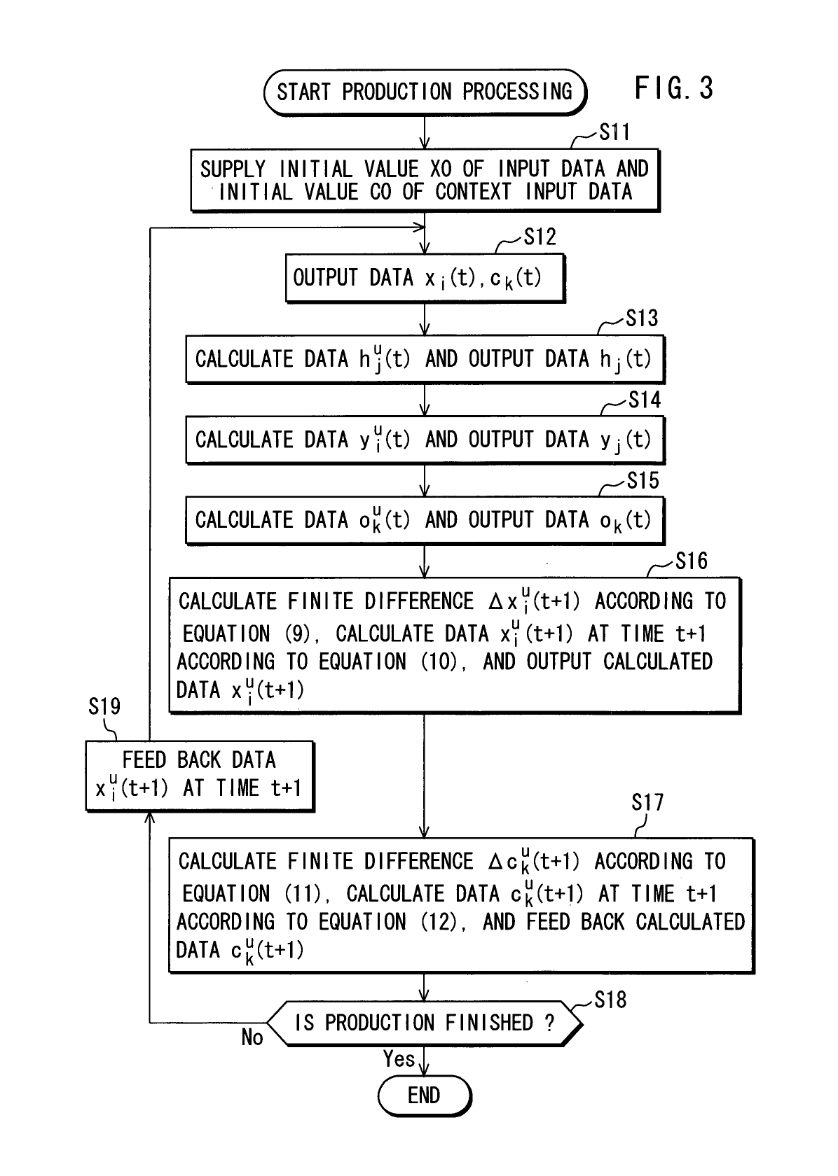

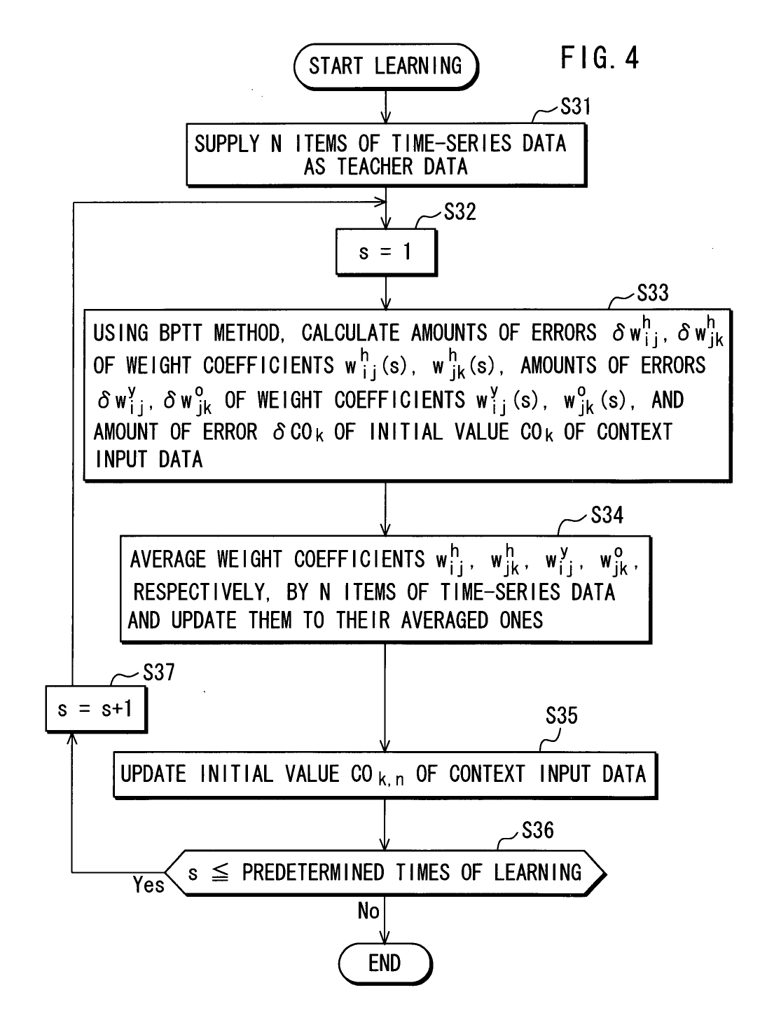

FIG. 4 is a flowchart of describing learning processing in the information-processing apparatus 10 that learns N items of time-series data corresponding to the N species of action sequences.

First, at Step S31, the production direction device 13 supplies the RNN device 12 with N items of time-series data as teacher data. The production direction device 13 also supplies the RNN device 12 with a predetermined value as the initial value c^{u}ₖ(t₀)=C0ₖ of the context input data of the N pieces of RNNS 41.

At Step S32, the operation portion 22 of the RNN device 12 substitutes one for a variable “s” indicating times of learning.

At Step S33, the operation portion 22 calculates amounts of errors δw^{h}ᵢⱼ, δw^{h}ⱼₖ of the weight coefficients w^{h}ᵢⱼ(s), w^{h}ⱼₖ(s) between nodes of the input layer 51 and nodes of the intermediate layer 52, amounts of errors δw^{y}ᵢⱼ, δw^{o}ⱼₖ of the weight coefficients w^{y}ᵢⱼ(s), w^{o}ⱼₖ(s) between nodes of the intermediate layer 52 and nodes of the output layer 53, and an amount of error δC0ₖ of the initial value C0ₖ of the context input data, using back propagation through time (BPTT) method, on the RNNS 41 corresponding to each of the N items of time-series data. In this case, in the RNN 41 to which the n-th time-series data (n=1, 2, . . . , N) is input, the amounts of errors whij, δw^{h}ᵢₖ, δw^{y}ᵢⱼ, δw^{o}ⱼₖ, δC0ₖ obtained by using BPTT method are respectively represented as the amounts of errors δw^{h}_{ij, n}, δw^{h}_{jk, n}, δw^{y}_{ij, n}, δw^{o}_{jk, n}, δC0_{k, n}.

BPTT method is a learning algorithm for the RNN 41 having a context loop, and by unfolding situation of signal propagation in time into space one, back propagation (BP) method used in the normal multilayer neural network is applied thereto. The weight coefficients w^{h}ᵢⱼ(s), w^{h}ⱼₖ(s), w^{y}ᵢⱼ(s), w^{o}ⱼₖ(s) are obtained so that an error between the data x^{u}(t+1) at time t+1 that is obtained from the data x^{u}(t) at time t and teacher data x^{u}(t+1)* at time t+1 can be made smaller.

It is to be noted that the operation portion 22 adjusts time constant of the context data by dividing, in the calculation using the BPTT method in Step S33, amount of error δc^{u}ₖ(t+1) of the data c^{u}ₖ(t+1) of the context input node 62-k at time t+1 by an optional positive coefficient m when the operation portion 22 performs back propagation on the amount of error δc^{u}ₖ(t+1) of the data c^{u}ₖ(t+1) of the context input nodes 62-k at time t+1 to the amount of error δoₖ(t) of the data oₖ(t) of the context output nodes 65-k at time t.

In other words, the operation portion 22 calculates the amount of error δoₖ(t) of the data oₖ(t) of the context output nodes 65-k at time t according to the following equation (13) using the amount of error δc^{u}ₖ(t+1) of the data c^{u}ₖ(t+1) of the context input nodes 62-k at time t+1:

$$δ {o}_{k} ( t ) = \frac{1}{m} δ {c}_{k}^{u} ( t + 1 ) \qquad ( 13 )$$

Adapting the equation (13) for the BPTT method enables influence of the context data of immediately before time step, which indicates internal state of the network, to be adjusted.

At Step S34, the operation portion 22 averages the weight coefficients w^{h}ᵢⱼ, w^{h}ⱼₖ between nodes of the input layer 51 and nodes of the intermediate layer 52, and the weight coefficients w^{y}ᵢⱼ, w^{o}ⱼₖ between nodes of the intermediate layer 52 and nodes of the output layer 53, respectively, by N items of time-series data, and updates the weight coefficients w^{h}ᵢⱼ, w^{h}ᵢₖ, w^{y}ᵢⱼ, w^{o}ⱼₖ to averaged ones.

Namely, the operation portion 22 calculates the weight coefficients w^{h}ᵢⱼ(s+1), w^{h}ᵢₖ(s+1) between nodes of the input layer 51 and nodes of the intermediate layer 52, and the weight coefficients w^{y}ᵢⱼ(s+1), w^{o}ⱼₖ(s+1) between nodes of the intermediate layer 52 and nodes of the output layer 53 according to the following equations (14) through (21):

$$\begin{matrix}Δ {w}_{ij}^{h} ( s + 1 ) = η \frac{1}{N} {\sum }_{n = 1}^{N} δ {w}_{ij , n}^{h} + α Δ {w}_{ij}^{h} ( s ) ; & ( 14 ) \\ {w}_{ij}^{h} ( s + 1 ) = {w}_{ij}^{h} ( s ) + Δ {w}_{ij}^{h} ( s + 1 ) ; & ( 15 ) \\ Δ {w}_{jk}^{h} ( s + 1 ) = η \frac{1}{N} {\sum }_{n = 1}^{N} δ {w}_{jk , n}^{h} + α Δ {w}_{jk}^{h} ( s ) ; & ( 16 ) \\ {w}_{jk}^{h} ( s + 1 ) = {w}_{jk}^{h} ( s ) + Δ {w}_{jk}^{h} ( s + 1 ) ; & ( 17 ) \\ Δ {w}_{ij}^{y} ( s + 1 ) = η \frac{1}{N} {\sum }_{n = 1}^{N} δ {w}_{ij , n}^{y} + α Δ {w}_{ij}^{y} ( s ) ; & ( 18 ) \\ {w}_{ij}^{y} ( s + 1 ) = {w}_{ij}^{y} ( s ) + Δ {w}_{ij}^{y} ( s + 1 ) ; & ( 19 ) \\ Δ {w}_{jk}^{o} ( s + 1 ) = η \frac{1}{N} {\sum }_{n = 1}^{N} δ {w}_{jk , n}^{o} + α Δ {w}_{jk}^{o} ( s ) ; and & ( 20 ) \\ {w}_{jk}^{o} ( s + 1 ) = {w}_{jk}^{o} ( s ) + Δ {w}_{jk}^{o} ( s + 1 ) . & ( 21 )\end{matrix}$$

In these equations, eta indicates a learning coefficient and alpha indicates an inertia coefficient. It is to be noted that in the equations (14), (16), (18), and (20), if s=1, the terms Δw^{h}ᵢⱼ(s), Δw^{h}ⱼₖ(s), Δw^{y}ᵢⱼ(s), Δw^{o}ⱼₖ(s) respectively become zero.

At Step S35, the operation portion 22 updates the initial value c0_{k,n} of the context input data. Namely, the operation portion 22 calculates the initial value c0_{k,n}(s+1) of the context input data according to the following equations (22) and (23):
Δc0_{k,n}(s+1)=ηδc0_{k,n}+αΔc0_{k,n}(s) (22); and
c0_{k,n}(s+1)=c0_{k,n}(s)+Δc0_{k,n}(s+1) (23).

At Step S36, the operation portion 22 determines whether or not the variable s is less than a predetermined times of learning. The predetermined times of learning are set to times so that learning error can be sufficiently made small.

If it is determined that the variable s is less than a predetermined times of learning, i.e., times of learning such that learning error can be sufficiently made small have not yet performed, at the Step S36, the processing goes to Step S37 where the operation portion 22 increments the variable s by one. The processing then goes to the Step S33. The processing further repeats the Steps S33 through S37. On the other hand, if it is determined that the variable s is not less than a predetermined times of learning, the learning processing ends.

It is to be noted that at the Step S36, the operation portion 22 can determine whether or not the learning error is involved within a predetermined reference limit. When it determines that the learning error is involved within the predetermined reference limit, the learning processing ends.

Thus, in the learning processing, processing such that the weight coefficients w^{h}ᵢⱼ, w^{h}ⱼₖ, w^{y}ᵢⱼ, w^{o}ⱼₖ are obtained for each action sequence and their average values become the weight coefficients w^{h}ᵢⱼ, w^{h}ⱼₖ, w^{y}ᵢⱼ, w^{o}ⱼₖ of final one RNN 41 is repeated, thereby obtaining the weight coefficients w^{h}ᵢⱼ, w^{h}ⱼₖ, w^{y}ᵢⱼ, w^{o}ⱼₖ of the RNN 41 to be used in production processing.

In such the processing, in other words, the weight coefficients w^{h}ᵢⱼ, w^{h}ⱼₖ between nodes of the input layer 51 and nodes of the intermediate layer 52, and the weight coefficients w^{y}ᵢⱼ, w^{o}ⱼₖ between nodes of the intermediate layer 52 and nodes of the output layer 53 are allocated to indiscrete part of the actions to the plural action sequences while the initial values c0_{k,n} of the context nodes are allocated to discrete part of the actions to the plural action sequences. Therefore, the initial values c0_{k,n} of the context nodes obtained by the learning processing have separate values for each action sequence. This allows the reproduced action sequence to alter based on the given initial values c0_{k,n} of the context nodes.

Although the weight coefficients w^{h}ᵢⱼ, w^{h}ⱼₖ, w^{y}ᵢⱼ, w^{o}ⱼₖ obtained for each action sequence have been averaged for each time in the above learning processing, they can be averaged for each of the predetermined times. For example, if the times of learning to be finished are 10,000 times, the weight coefficients w^{h}ᵢⱼ, w^{h}ⱼₖ, w^{y}ᵢⱼ, w^{o}ⱼₖ obtained for each action sequence may be averaged for each ten times of learning.

The following will describe the learning processing and the production processing of the time-series data of the above information-processing apparatus 10 based on results of experiments in which a humanoid robot acted.

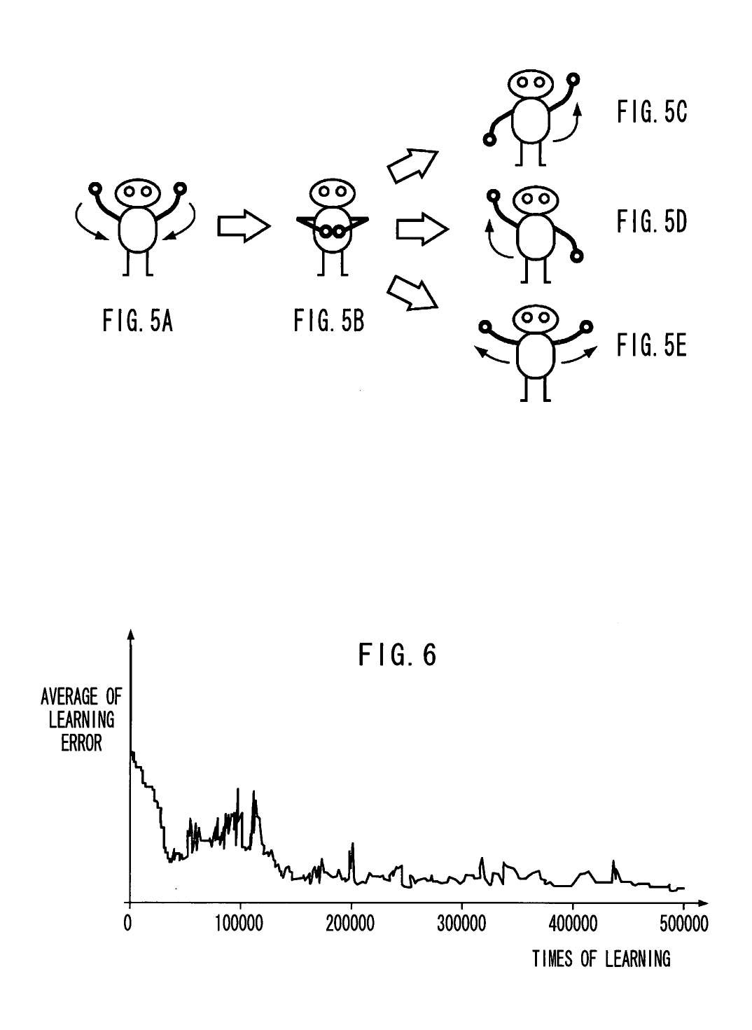

Specifically, as shown in FIGS. 5A through 5E, the robot behaved in the same way from its initial state (a) (see FIG. 5A) up to its immediate state (b) (see FIG. 5B) while the robot behaved in separate ways from its immediate state (b) to each of the final states (c1) through (c3) based on each of the different action sequences D1 through D3. The robot behaved as if he held up his left hand based on the action sequence D1 (see FIG. 5C). The robot behaved as if he held up his right hand based on the action sequence D2 (see FIG. 5D). The robot behaved as if he held up both of his hands based on the action sequence D3 (see FIG. 5E). It is to be noted that the action sequences D1 through D3 have time step numbers from 69 to 79 steps as time steps in the RNN 41.

Time-series data given to the RNN device 12 as teacher data relates to signals on a joint motor for robot. In this experiment, node number of the input nodes 61 in the RNN 41 was set to eight (I=8); node number of the hidden nodes therein was set to twenty (J=20); node number of the context input nodes 62 therein was set to ten (K=10); and node number of the output nodes 64 therein was set to eight (I=8). Numbers of learning were set to 500,000 times to perform the learning. Therefore, the robot was controlled with eight-axis motor to perform D5 the action sequences D1 through D3.

In this experiment, learning was performed in which a total of 15 items of time-series data obtained by adding five species of noises that was slightly different one from another to each of the action sequences D1 through D3 was set as teacher data. Weight coefficients in the RNN 41 that were common to the 15 items of time-series data were obtained and the initial values C0 of the context input data to the 15 items of time-series data were obtained.

FIG. 6 shows a change of learning error when in the learning processing of one action sequence, the robot learns time-series data of eight-axis motor signal at 500,000 times. In FIG. 6, a horizontal axis indicates times of learning and vertical axis indicates an average of learning error of the time-series data of eight-axis motor signal.

It has been seen that at the learning of 500,000 times, the learning error converges sufficiently, except somewhat fluctuation.

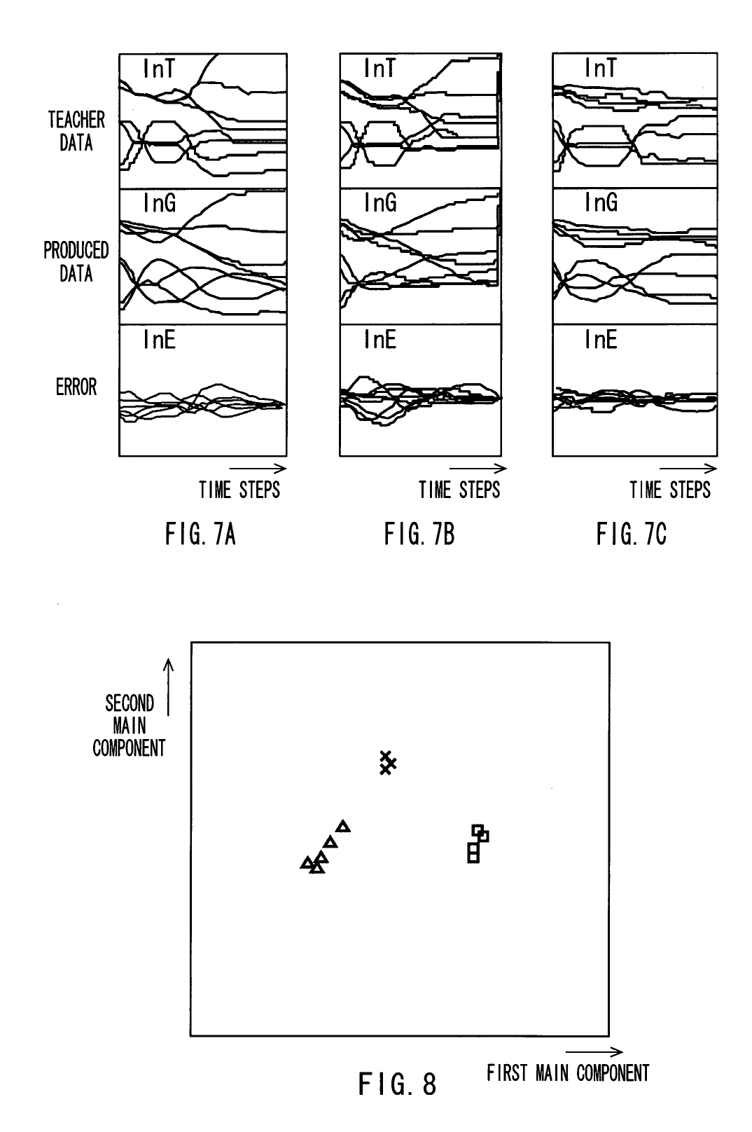

FIGS. 7A through 7C respectively show comparison results between the teacher data used in the learning processing and the produced data produced in production processing.

FIG. 7A shows a comparison result of one action sequence among five action sequences D1. FIG. 7B shows a comparison result of one action sequence among five action sequences D2. FIG. 7C shows a comparison result of one action sequence among five action sequences D3.

In each of the FIGS. 7A through 7C, three graphs are arranged vertically. A top graph of the three graphs represents the teacher data which is supplied to the RNN device 12 in the learning processing. The teacher data relates to time-series data of motor signal. A middle graph thereof represents the produced data that is produced in the RNN device 12 in the learning processing. The produced data also relates to time-series data of motor signal. A bottom graph represents an error between the teacher data and the produced data. Horizontal axis in each of the FIGS. 7A through 7C indicates numbers of time steps in the RNN 41.

As seen from every graph of FIGS. 7A through 7C, the produced data in the middle graph is almost like the teacher data in the top graph so that the produced data can include features of the teacher data. In other words, the actions of robot have been accurately reproduced, thereby enabling learning and/or production of long sequences of almost from 69 to 79 sequences to be realized.

The following will describe initial values C0 of the context input data that is obtained in the learning processing.

FIG. 8 shows a result of two-dimensionally projecting the initial values C0 of the context input data that is obtained in the above learning processing of the fifteen action sequences by analyzing main components thereof. In FIG. 8, a horizontal axis indicates a first main component thereof and a vertical axis indicates a second component thereof.

In FIG. 8, the initial values c0 of the context input data on five action sequences D1 are plotted on the graph by square marks; the initial values c0 of the context input data on five action sequences D2 are plotted on the graph by x marks; and the initial values c0 of the context input data on five action sequences D3 are plotted on the graph by triangular marks. It is to be noted that in FIG. 8, the initial values c0 of the context input data on the action sequences D1, D2 are plotted on the graph by only four square marks and three x marks, respectively, not five ones, some of the plotted marks of which are overlapped to see as if they are identical one.

As seen from FIG. 8, the initial values c0 of the context input data on the action sequences D1, D2, D3 are sufficiently separated from one another so that each of the initial values c0 of the context input data on the action sequences D1, D2, D3 can cluster.

Thus, it is possible to switch the action sequences D1 through D3 sufficiently based on the initial values c0 of the context input data that is input to the RNN 41 even if the initial values X0 of the input data that is input to the input node 61 of the RNN 41 is identical when the initial state (a) is identical. In other words, the initial values c0 of the context input data for switching the action sequences D1 through D3 are self-assembled by the learning processing.

Thus, the RNN 41 included in the RNN device 12 enables to be realized with stability the learning of sequences (of time-series data) including a branch structure such that the initial values X0 of the input data that is input to the first input node 61 of the RNN 41 is identical but vary in its midstream irrespective of long time sequences from 69 to 79 time steps.

The above series of processing can be realized by not only hardware but also software. If the series of processing is realized by the software, program pieces constituting this software are installed into a computer embedded in special purpose hardware or a computer that can perform various kinds of functions by installing various kinds of program pieces, for example, a multi-purpose personal computer, from a program storage medium.

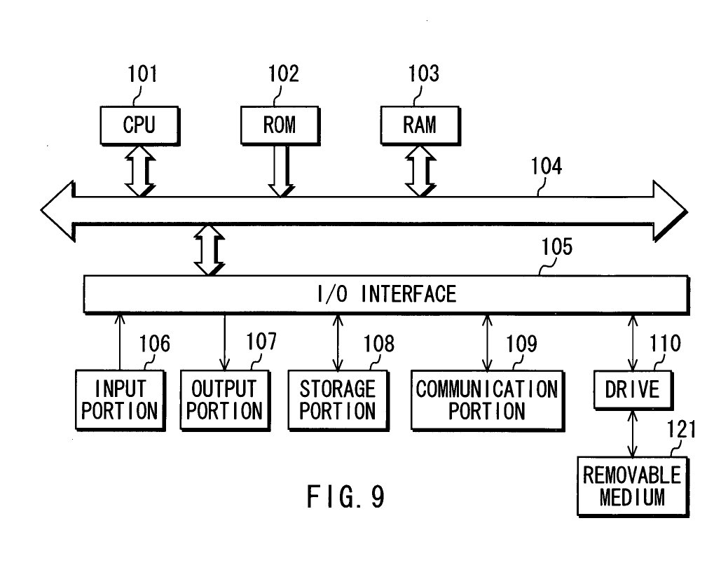

FIG. 9 shows a configuration of an embodiment of the personal computer that can perform the above series of processing based on any program. Central processing unit (CPU) 101 allows various kinds of processing to be performed based on any program stored in a read only memory (ROM) 102 or a storage portion 108. A random access memory (RAM) 103 appropriately stores program and/or data that the CPU 101 uses for performing various kinds of functions. The CPU 101, the ROM 102, and the RAM 103 are connected to each other via bus 104.

An input/output interface 105 is connected to the CPU 101 via the bus 104. To the input/output interface 105, an input portion 106 containing a key board, a mouse, a microphone and the like and an output portion 107 containing a display such as a cathode ray tube (CRT) and a liquid crystal display (LCD), a speaker and the like are connected. The CPU 101 allows various kinds of processing to be performed corresponding to any commands input by the input portion 106. The CPU 101 also allows results of the processing to be output to the output portion 107.

The storage portion 108 connected to the input/output interface 105 contains a hard disk and stores program and/or various kinds of data that the CPU 101 uses for performing various kinds of functions. A communication portion 109 communicates with any outer apparatus via a network such as the Internet and a local area network or directly if the communication portion 109 is connected to the outer apparatus.

A drive 110 connected to the input/output interface 105 drives a removable medium 121 such as a magnetic disk, an optical disk, a magneto-optical disk or a semiconductor memory when the removable medium is installed thereinto for obtaining the stored program and/or data. The program and/or data thus obtained are transferred to the storage portion 108 as occasion demands. The storage portion 108 stores the transferred program and/or data. The program and/or data may be obtained through the communication portion 109 and stored in the storage portion 108.

The program storage medium storing the programs to be installed in a computer and to be performed by the computer is constituted of the removable media 121 shown in FIG. 9 such as a magnetic disk including a flexible disk, an optical disk including compact disk-read only memory (CD-ROM) and digital versatile disk (DVD), a magneto-optical disk or a semiconductor memory as package medium. The program storage medium may be constituted of ROM 102 that stores the program temporarily or permanently, or a hard disk constituting the storage portion 108. The program is stored in the program storage medium using any wired or wireless communication medium such as the local area network, the internet, digital satellite broadcasting through the communication portion 109 that is an interface such as a router or a modem as occasion demands.

The steps in the flowcharts shown in FIGS. 3, 4 are processed according to an order described in the specification but the invention is not limited thereto. The steps may be processed in parallel or separately.

It should be understood by those skilled in the art that various modifications, combinations, sub-combinations and alternations may occur depending on design requirements and other coefficients insofar as they are within the scope of the appended claims or the equivalents thereof.

What is claimed is:

1. An information-processing apparatus equipped with a recurrent neural network containing:
an input node that allows data to be input;
an output node that outputs data based on the data input through the input node
a context input node;
a context output node;
a context loop that returns a value indicating internal state in the network from the context output node to the context input node; and
a recurrent loop that returns output from the network at predetermined time to the network as a next input to the network,
the apparatus comprising a production device that produces a current input to the network by adding output from the output node into an immediately preceding input to the network at a predetermined rate, and produces a current input to the context input node by adding output from the context output node into an immediately preceding input to the context input node at a predetermined rate.

2. The information-processing apparatus according to claim 1 wherein the production device produces internal state of the input node at immediate future after current time by adding the output from the output node into internal state of the input node at the current time at a predetermined rate, and produces internal state of the context input node at immediate future after the current time by adding the output from the context output node into the internal state of the context input node at the current time at a predetermined rate.

3. The information-processing apparatus according to claim 2 wherein an initial value given to the context input node is obtained by learning; and
wherein in the learning, influence by an error in the internal state of the context input node at predetermined time on an error in the internal state of the context output node immediately before the predetermined time is adjusted.

4. A method of processing information by using a recurrent neural network containing:
an input node that allows data to be input;
an output node that outputs data based on the data input through the input node;
a context input node;
a context output node;
a context loop that returns a value indicating internal state in the network from the context output node to the context input node; and
a recurrent loop that returns output from the network at predetermined time to the network as a next input to the network, the method comprising the steps of:
producing a current input to the network by adding output from the output node into an immediately preceding input to the network at a predetermined rate; and
producing a current input to the context input node by adding output from the context output node into an immediately preceding input to the context input node at a predetermined rate.

5. A program product that allows a computer to perform a method of processing information by using a recurrent neural network containing:
an input node that allows data to be input;
an output node that outputs data based on the data input through the input node;
a context input node;
a context output node;
a context loop that returns a value indicating internal state in the network from the context output node to the context input node; and
a recurrent loop that returns output from the network at predetermined time to the network as a next input to the network, the method comprising the steps of:
producing a current input to the network by adding output from the output node into an immediately preceding input to the network at a predetermined rate; and
producing a current input to the context input node by adding output from the context output node into an immediately preceding input to the context input node at a predetermined rate.

6. Learning device that learns an initial value provided to a context input node of an information-processing apparatus, the information-processing apparatus being equipped with a recurrent neural network containing:
an input node that allows data to be input;
an output node that outputs data based on the data input through the input node;
a context input node;
a context output node;
a context loop that returns a value indicating internal state in the network from the context output node to the context input node; and
a recurrent loop that returns output from the network at predetermined time to the network as a next input to the network,
wherein the learning device comprises an adjusting device that adjusts influence by an error in the internal state of the context input node at predetermined time on an error in the internal state of the context output node immediately before the predetermined time.

7. The learning device according to claim 6 wherein the adjusting device sets a value obtained by dividing the error in the internal state of the context input node at predetermined time by a positive coefficient as the error in the internal state of the context output node immediately before the predetermined time, to adjust the influence by the error in the internal state of the context input node at the predetermined time on the error in the internal state of the context output node immediately before the predetermined time.

8. A learning method of learning an initial value provided to a context input node of an information-processing apparatus, the information-processing apparatus being equipped with a recurrent neural network containing:
an input node that allows data to be input;
an output node that outputs data based on the data input through the input node;
a context input node;
a context output node;
a context loop that returns a value indicating internal state in the network from the context output node to the context input node; and
a recurrent loop that returns output from the network at predetermined time to the network as a next input to the network,
the method including a step of adjusting influence by an error in the internal state of the context input node at predetermined time on an error in the internal state of the context output node immediately before the predetermined time.

9. A program product that allows a computer to perform a learning method of learning an initial value provided to a context input node of an information-processing apparatus, the information-processing apparatus being equipped with a recurrent neural network containing:
an input node that allows data to be input;
an output node that outputs data based on the data input through the input node;
a context input node;
a context output node;
a context loop that returns a value indicating internal state in the network from the context output node to the context input node; and
a recurrent loop that returns output from the network at predetermined time to the network as a next input to the network,
the method including a step of adjusting influence by an error in the internal state of the context input node at predetermined time on an error in the internal state of the context output node immediately before the predetermined time.
